(19) United States
(12) Patent Application Publication
(10) Pub. No.: US 2025/0117835 A1
(43) Pub. Date: Apr. 10, 2025

(54) CALCULATING APPARATUS, CALCULATING METHOD, AND PROGRAM

(71) Applicant: NIPPON TELEGRAPH AND TELEPHONE CORPORATION, Tokyo (JP)

(72) Inventors: Yukitaka TSUCHIYA, Tokyo (JP); Atsushi NAKADAIRA, Tokyo (JP); Shigenori OHASHI, Tokyo (JP); Keita SUZUKI, Tokyo (JP); Honoka TODA, Tokyo (JP)

(73) Assignee: NIPPON TELEGRAPH AND TELEPHONE CORPORATION, Tokyo (JP)

(21) Appl. No.: 18/729,879

(22) PCT Filed: Jan. 26, 2022
(86) PCT No.: PCT/JP2022/002784

§ 371 Date: Jul. 17, 2024

(51) Int. Cl. G06Q 30/0601; G06Q 30/0202; G06Q 30/0282

(52) U.S. Cl. CPC G06Q 30/0609; G06Q 30/0202; G06Q 30/0282

(57) ABSTRACT

The present invention provides a computation device or the like that computes an index (hereinafter also referred to as “importance level”) used to control display of information of a web page browsed when a purchaser considers product purchase in an online transaction. The computation device includes an importance level computation unit that computes an importance level that is an index indicating how much importance a user who intends to purchase a product places on human information and thing information by using an operation log of a web page and human thing information, in which the human information is information regarding a user who sells a product, and the thing information is information regarding a product, and the human thing information is information indicating whether each piece of content on the web page is the human information or the thing information.

### TECHNICAL FIELD

The present invention relates to a technique for presenting information.

### BACKGROUND ART

In purchasing and selling things between individuals online, a user who sells a product (hereinafter, also simply referred to as a “seller”) discloses product information and user information, and a user who intends to purchase a product (hereinafter, also simply referred to as a “purchaser”) selects and pays for a thing to purchase from various products sold by a plurality of users (sellers). The product information is, for example, information regarding a selectable product such as a price, an image, an open-ended description, a category, and a product state, information related to selectable product sales such as a burden of a delivery fee and the number of days until delivery, and the like. User information is, for example, a user name, an account image, the number of transactions, transaction evaluation, comment handling, the number of likes, and other selling items. So far, a method of creating a recommendation list by using purchase information of each purchaser (refer to Patent Literature 1), a method of updating the degree of interest in an object of interest from a behavior history of each user (refer to Patent Literature 2), and the like have been proposed.

### CITATION LIST

### Patent Literature

Patent Literature 1: JP 2013-109665 A

Patent Literature 2: JP 2011-175442 A

### SUMMARY OF INVENTION

### Technical Problem

In online transactions of things (for example, a transaction between individuals or a transaction between a company and an individual), an amount or a quality of information disclosed by a seller is different. On the other hand, information regarded as important for a purchaser to make a decision to purchase is different. In particular, in a transaction between individuals, there is a large difference in an amount or a quality of information disclosed by a seller, and there are some purchasers who place importance on only the product information and some purchasers who place importance on both the product information and the user information at the time of purchase.

However, the conventional product recommendation based on a purchase history is mainly recommendation based on information regarding a purchase history of a purchaser, and does not consider on which information the purchaser places importance to make a decision to purchase. Thus, there is a problem that it takes time to select a product, which may lead to a decrease in convenience and a decrease in a matching rate. For example, there is a case where it takes time for a purchaser who places importance on user information of a seller to select a favorite product from among recommended products and further select a seller from whom a product can be purchased with security from among sellers of the product.

In the conventional method of updating the degree of interest of a user, the degree of interest in information regarding a product or a service is calculated, but user information is not considered. In online transactions of things, it is necessary to pay attention to user information, and as described above, which of product information and user information with different properties is regarded as important differs depending on purchasers.

An object of the present invention is to provide a computation device, a computation method, and a program for computing an index (hereinafter, also referred to as an “importance level”) used to control display of information of a web page browsed when a purchaser considers product purchase in an online transaction. The importance level is an index indicating how much importance is placed on human information and thing information. The human information is information regarding a user who is a seller of a product, and is, for example, a user name, an account image, the number of transactions, transaction evaluation, comment handling, the number of likes, and other selling items. The thing information is information regarding a product, and is, for example, information regarding a selectable product such as a price, an image, an open-ended description, a category, and a product state, information related to selectable product sales such as a burden of a delivery fee and the number of days until delivery, and the like.

### Solution to Problem

In order to solve the above problems, according to one aspect of the present invention, there is provided a computation device including an importance level computation unit that computes an importance level that is an index indicating how much a user who intends to purchase a product places importance on human information and thing information by using an operation log L of a web page and human thing information, in which the human information is information regarding a user who sells a product, the thing information is information regarding a product, and the human thing information is information indicating whether each piece of content on the web page is the human information or the thing information.

### Advantageous Effects of Invention

According to the present invention, effects are achieved in which it is possible to control display of information of a web page by using an importance level, to display information itself that is regarded as important by a purchaser in an easily accessible manner, or to display a web page that is rich in information that is regarded as important by a purchaser in an easily accessible manner.

### BRIEF DESCRIPTION OF DRAWINGS

FIG. 1 is a diagram illustrating a configuration example of a presentation system according to a first embodiment.

FIG. 2 is a functional block diagram of an importance level computation device according to the first embodiment.

FIG. 3 is a diagram illustrating an example of a processing flow of initial value calculation.

FIG. 4 is a diagram illustrating an example of a processing flow of update of an importance level, update of enrichment, and layout customization.

FIG. 5 is a diagram illustrating a configuration example of a computer to which the present method is applied.

### DESCRIPTION OF EMBODIMENTS

Hereinafter, embodiments of the present invention will be described. Note that, in the drawings to be used in the description below, components having the same functions or steps for performing the same processing will be denoted by the same reference numerals/signs, and description thereof will not be repeated. In the following description, processing to be performed for each element of a vector or a matrix is applied to all elements of the vector or the matrix, unless otherwise specified.

### First Embodiment

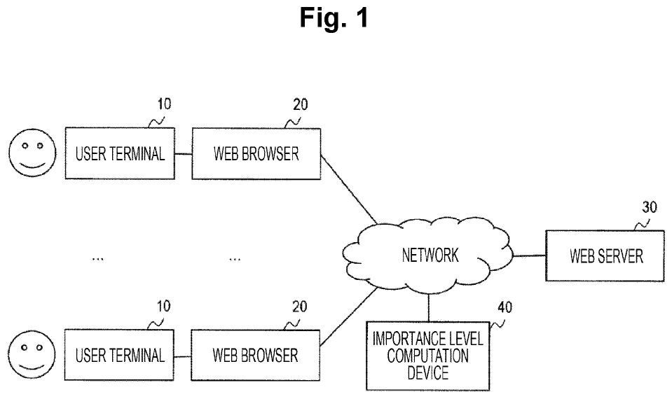

FIG. 1 illustrates a configuration example of a presentation system according to a first embodiment. The presentation system includes a user terminal 10, a web browser 20, a web server 30, and an importance level computation device 40.

### User Terminal 10, Web Browser 20, and Web Server 30

The user terminal 10 is a terminal operated by a user (purchaser), and is, for example, a personal computer or a smartphone.

The web server 30 is a server computer on which a service that provides display of predetermined data (Hypertext Markup Language (HTML) or an object (such as an image)) to the web browser 20 according to a predetermined protocol (for example, Hypertext Transfer Protocol (HTTP)) operates. In the present embodiment, the predetermined data includes thing information and human information, and the web server 30 constructs an EC site.

The web browser 20 is software for connection to the web server 30 via a network, and has functions such as displaying a web page and following a hyperlink. The web browser 20 is implemented on the user terminal 10. The web browser 20 requests the web server 30 that manages a web page specified by a user to transmit data via the user terminal 10, and reads and displays transmitted predetermined data (HTML or an object (image or the like)) in a designated layout.

### Importance Level Computation Device 40

The importance level computation device 40 is communicatively connected to the web browser 20 via a network, receives an answer result A of a questionnaire regarding information regarded as important, an importance level P, an operation log L of a web page, and information i of the web page from the web browser 20, computes the importance level P, and outputs information h of a customized web page to the web browser 20. The importance level P is an initial value Pᵢₙᵢ of the importance level P or an updated importance level Pᵤₚ. Note that the information of the web page includes an identifier of the web page, information regarding content on the web page (for example, the content itself), and information regarding a layout of the content on the web page.

The importance level computation device 40 has the following three functions.

### Function 1: Importance Level Computation

The importance level computation device 40 computes the initial value Pᵢₙᵢ of the importance level P from the answer result A of the questionnaire regarding the information regarded as important, and updates the importance level P from the operation log L of the web page of a purchaser. Note that the importance level P is computed for each purchaser.

### Function 2: Enrichment Computation

The importance level computation device 40 computes the enrichment f of the content (human information and thing information) in the web page by using the operation log L of the purchaser whose importance level P is known. Note that the enrichment f is computed for each web page.

### Function 3: Customization of Web Page

The importance level computation device 40 performs customization (rearranging, highlighting, layout change, and the like) of the web page by using the importance level P of the purchaser and the enrichment f. Note that customization of a web page is performed for each combination of a purchaser and a web page.

Hereinafter, the importance level computation device 40 that realizes the above-described functions 1 to 3 will be described.

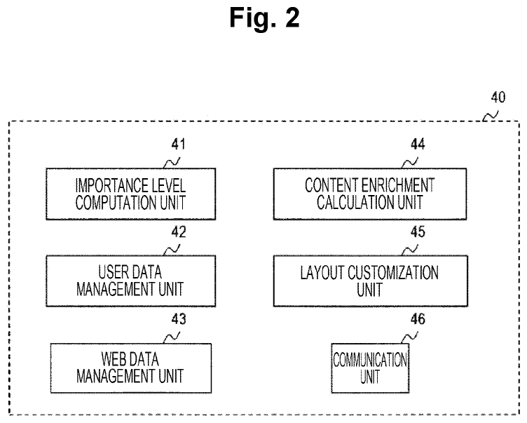

FIG. 2 is a functional block diagram of the importance level computation device 40. The importance level computation device 40 includes an importance level computation unit 41, a user data management unit 42, a web data management unit 43, a content enrichment calculation unit 44, a layout customization unit 45, and a communication unit 46.

The importance level computation device is, for example, a special device configured by reading a special program in a known or dedicated computer having a central processing unit (CPU), a main storage device (random access memory (RAM)), and the like. The importance level computation device executes each process under the control of the central processing unit, for example. Data input to the importance level computation device and data obtained through each process are stored in, for example, the main storage device, and the data stored in the main storage device is read to the central processing unit as necessary and used for other processes. At least a part of each processing unit of the importance level computation device may be configured by hardware such as an integrated circuit. Each storage unit included in the importance level computation device may be configured by, for example, a main storage device such as a random access memory (RAM) or middleware such as a relational database or a key value store. However, each storage unit is not necessarily provided inside the importance level computation device, and may be configured by an auxiliary storage device including a semiconductor memory element such as a hard disk, an optical disc, or a flash memory, and may be provided outside the importance level computation device.

Hereinafter, each of the units will be described.

### Communication Unit 46

The importance level computation device 40 is communicatively connected to the web browser 20 via the communication unit 46. The importance level computation device 40 receives, from the web browser 20 via the communication unit 46, the answer result A of the questionnaire regarding information regarded as importance that will be described later, the operation log L of the web page, and the information i of the web page, and transmits the initial value Pᵢₙᵢ of the importance level P or the updated importance level Pᵤₚ, and the information h of the customized web page to the web browser 20 via the communication unit 46.

### User Data Management Unit 42

The user data management unit 42 receives the user identifier, the answer result A of the questionnaire, the operation log L of the web page, and the importance level P (the initial value Pᵢₙᵢ or the updated importance level Pᵤₚ) computed by the importance level computation unit 41 that will be described later, and performs data management. Here, the “data management” is a concept including safe storage of data itself and construction of a database for easy search by adding, correcting, changing, deleting, and the like of data.

### Web Data Management Unit 43

The web data management unit 43 receives the information i of the web page and the enrichment f obtained through calculation in the content enrichment calculation unit 44 that will be described later, and performs data management as data together with information (hereinafter, also referred to as “human thing information”) g indicating whether each piece of content on the web page is human information or thing information. The information regarding the content on the web page included in the information i of the web page and the human thing information g are stored as a set. For example, the human thing information g is known, and each piece of content on the web page is attached with a tag indicating whether the content is human information or thing information. For example, whether certain content is human information or thing information is stored in advance as a list, whether each piece of content on a web page is human information or thing information is determined with reference to the list, and a combination of information regarding each piece of content and a determination result (information indicating whether the content is human information or thing information, that is, the human thing information g) is stored. For example, a model for classifying whether certain content is human information or thing information is trained in advance through machine learning, whether each piece of content on a web page is human information or thing information is classified by using the trained model, and a combination of information regarding each piece of content and a classification result (information indicating whether the content is human information or thing information, that is, the human thing information g) is stored.

### Importance Level Computation Unit 41

The importance level computation unit 41 receives the answer result A of the questionnaire or the importance level P, the operation log L of the web page, and the human thing information g stored in the web data management unit 43, computes the importance level P (the initial value Pᵢₙᵢ or the updated importance level Pᵤₚ) by using the calculation model stored in the importance level computation unit 41 with these values as inputs, and outputs the computed importance level P to the user data management unit 42. The importance level P is stored in the user data management unit 42. The importance level P includes a human information importance level indicating how much importance is placed on human information at the time of transaction, and a thing information importance level indicating how much importance is placed on thing information at the time of transaction. The human information importance level may be an index including a plurality of values by assigning values to a plurality of items to be considered when the human information importance level is calculated, or may be an index including one value obtained by weighting and adding a plurality of values. Similarly, the thing information importance level may be an index including a plurality of values, or may be an index including one value.

### Initial Value Calculation

Before a user browses the web page via the web browser 20 and the user terminal 10, the importance level computation unit 41 conducts a questionnaire regarding information on which the user places importance, for example, a questionnaire regarding how much the user places importance on the thing information and the human information, and receives the answer result A of the questionnaire. In the questionnaire, for example, one or more items to be considered in calculating the human information importance level and the thing information importance level are evaluated in seven-stage evaluation (7: very important, 6: somewhat important, 5: rather important, 4: not either, 3: rather unimportant, 2: not very important, 1: not at all important).

For example, in order to compute an initial value of the human information importance level, the questionnaire includes questions such as “Do you place importance on the price of a product?”, “Do you place importance on an image of an item?”, and “Do you place importance on a product description?”.

For example, in order to compute an initial value of the human information importance level, the questionnaire includes questions such as “Do you place importance on the number of transactions of a seller?”, “Do you place importance on transaction evaluation for a seller?”, and “Do you place importance on comment handling of a seller?”.

The importance level computation unit 41 obtains the initial value Pᵢₙᵢ of the importance level P on the basis of the answer result A of the questionnaire, and outputs the initial value Pᵢₙᵢ to the user data management unit 42. For example, the answer result A of the questionnaire may be used as the initial value of the importance level P without any change, or an answer result related to the human information importance level may be weighted and added to obtain the human information importance level including one value, and an answer result related to the thing information importance level may be weighted and added to obtain the thing information importance level including one value.

### Update of Importance Level

The importance level computation unit 41 updates the importance level P by using the operation log L of the web page, the human thing information g, and the importance level P before the update as inputs, and outputs the updated importance level Pᵤₚ to the user data management unit 42.

An example of a method of updating the importance level P from the operation log L of the web page and the human thing information g will be described.

(Update method 1) The importance level P is updated on the basis of the time of content displayed on a screen. For example, in a case where a large amount of human information is viewed, that the human information importance level is updated to be high. For example, in a case where the time during which the thing information is displayed is short, the thing information importance level is updated to be low. For example, a model that returns a greater value as an importance level corresponding to content as the display time of the content becomes longer is created in advance, an importance level is obtained from the display time of the content, and a weighted sum of the obtained importance level and the importance level before being updated is set as an importance level after being updated.

(Update method 2) The importance level P is updated on the basis of a rate of following a link of the user information. For example, in a case where human information is always viewed every time, the human information importance level is updated to be high. For example, in a case where the link is scarcely followed, the human information importance level is updated to be low. For example, a model that returns a greater value as the human information importance level as a rate of following the link of the human information becomes higher is created in advance, the human information importance level is obtained from the rate of following the link of the human information, and a weighted sum of the obtained human information importance level and the human information importance level before being updated is set as a human information importance level after being updated.

(Update method 3) The importance level P is updated on the basis of the number of times an image is scrolled. For example, in a case where the thing information is viewed many times by scrolling the image, the thing information importance level is updated to be high. For example, a model that returns a greater value as the thing information importance level as the number of times of scrolling the image becomes larger is created in advance, the thing information importance level is obtained from the number of times of scrolling the image, and a weighted sum of the obtained thing information importance level and the thing information importance level before being updated is set as a thing information importance level after being updated.

(Update method 4) The importance level P is updated on the basis of the number of times an image is enlarged. For example, in a case where the thing information is viewed in detail by enlarging an image many times, the thing information importance level is updated to be high. For example, a model that returns a greater value as the thing information importance level as the number of times of enlarging the image becomes larger is created in advance, the thing information importance level is obtained from the number of times of enlarging the image, and a weighted sum of the obtained thing information importance level and the thing information importance level before being updated is set as a thing information importance level after being updated.

The above-described update methods are examples, and an importance level may be updated according to another method. In short, whether or not the thing information is regarded as important, or whether or not the thing information importance level is regarded as important is obtained from the operation log, and the importance level before being updated may be updated by using the obtained importance level.

### Content Enrichment Calculation Unit 44

The content enrichment calculation unit 44 uses the operation log L of the web page, the human thing information g, and the importance level P as inputs, and calculates the enrichment f by using a calculation model stored in the content enrichment calculation unit 44. The calculated enrichment f is stored in the web data management unit 43. The enrichment f includes human information enrichment indicating whether the human information on the web page is enriching, and thing information enrichment indicating whether the thing information on the web page is enriching.

For example, the enrichment f of the content of the web page is evaluated on the basis of the time or the number of times a purchaser in the state in which the importance level P is known performs browsing.

### Example of Enrichment Evaluation Method

(Example 1) In a case where the time in which user information in the web page is browsed by a person with a high human information importance level is long, it is evaluated that the human information enrichment is high, and in a case where the time is short, it is evaluated that the human information enrichment is low. On the other hand, it is assumed that the length of time in which browsing is performed by a person with a low human information importance level does not affect the human information enrichment. Whether the importance level is low or high may be determined on the basis of a magnitude relationship with a predetermined threshold.

(Example 2) In a case where the number of times an image in a web page is browsed by a person with a high thing information importance level is large, it is evaluated that the thing information enrichment is high, and in a case where the number of times is small, it is evaluated that the thing information enrichment is low. On the other hand, it is assumed that the number of times an image in a web page is browsed by a person with a low thing information importance level being large does not affect the thing information enrichment.

These evaluations may be performed on one or more users who browse the web page, and information regarding how many people at the importance level P are involved in the evaluations may be stored in a list and updated. For example, in a case where a certain user has browsed a certain web page, an enrichment may be obtained from the operation log L and the importance level P of the web page of the user, and the enrichment before being updated may be updated by using the obtained enrichment.

### Layout Customization Unit 45

The layout customization unit 45 uses the importance level P of the purchaser, the enrichment f of the web page, the information i of the web data, and the human thing information g as inputs, and performs customization (rearranging, highlighting, layout change, and the like) of the web page in accordance with the importance level P of a purchaser and the enrichment f of the web page. Note that, as described above, the information i of the web data includes an identifier of the web page, information regarding the content on the web page (for example, the content itself), and information regarding a layout of the content on the web page.

The importance level P, the information i of the web data, the human thing information g, and the enrichment f are input, and a layout in the web is customized by using the customization model stored in the layout customization unit 45. For example, the layout customization unit 45 customizes the layout to preferentially display information regarded as important by each purchaser on the basis of the importance level P and the enrichment f.

### EXAMPLE OF CUSTOMIZATION METHOD

### (Example 1) Rearranging

In a case of a purchaser with a high human information importance level, the layout is customized such that products on a web page with a high human information enrichment are preferentially displayed at a high level.

In a case of a purchaser with a high thing information importance level, the layout is customized such that products on a web page with a high thing information enrichment are preferentially displayed at a high level.

For example, the layout customization unit 45 determines whether or not the importance level is high on the basis of a magnitude relationship between the importance level P of the purchaser and a predetermined threshold value, performs ranking on the basis of the enrichment f of web pages, and preferentially displays web pages with high rankings such that the web pages can be easily accessed.

### (Example 2) Highlighting

In a case of a purchaser with a high human information importance level, the layout is customized such that products on a web page with a high human information enrichment are displayed by being surrounded by a frame or displayed to be enlarged.

In a case of a purchaser with a high thing information importance level, the layout is customized such that products on a web page with a high thing information enrichment are displayed by being surrounded by a frame or displayed to be enlarged.

For example, the layout customization unit 45 determines whether or not the importance level is high on the basis of a magnitude relationship between the importance level P of the purchaser and a predetermined threshold value, determines whether or not the web page has a high enrichment on the basis of a magnitude relationship between the enrichment f of the web page and a predetermined threshold value, and preferentially displays a web page having the high enrichment such that the web page is conspicuous and easy to access.

### (Example 3) Layout Change

In a case of a purchaser with a high human information importance level, positions of the human information and the thing information are changed such that content related to the human information on the web page is more easily accessed than content related to the thing information.

In a case of a purchaser with a high thing information importance level, positions of the human information and the thing information are changed such that content related to the thing information on the web page is more easily accessed than the content related to the human information.

For example, the layout customization unit 45 determines whether or not the importance level is high on the basis of a magnitude relationship between the importance level P of the purchaser and a predetermined threshold value, customizes information regarding a layout of content on the web page included in the information i of the web data, and changes positions of the human information and the thing information on the web page such that content with a high importance level is easily accessed.

Hereinafter, a processing flow of the importance level computation device 40 will be described.

### Processing Flow of Initial Value Calculation

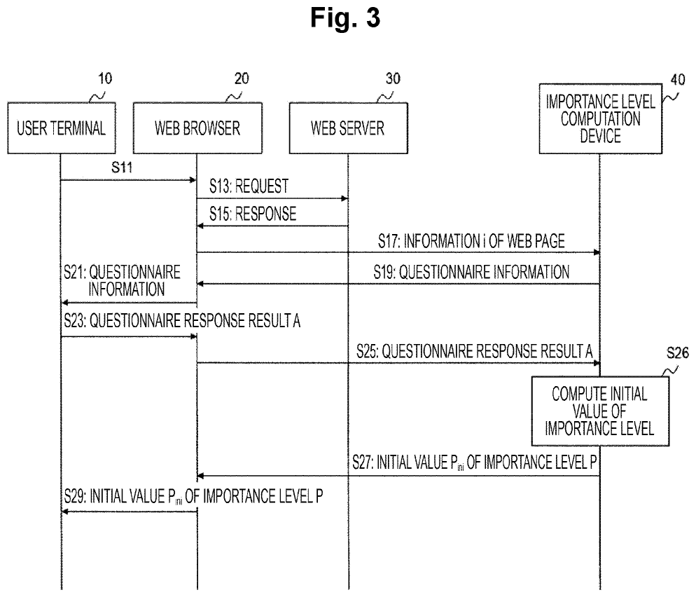

FIG. 3 illustrates an example of a processing flow of initial value computation.

A purchaser operates the user terminal 10 (S11) to access the web server 30 via the web browser 20. In this case, the web browser 20 transmits a request to the web server 30 (S13), and the web server 30 returns a response to the web browser 20 (S15).

When the web browser 20 accesses the web server 30 for the first time, the web browser 20 transmits the information i of a web page that has accessed the importance level computation device 40 (S17).

In a case where the purchaser uses the presentation system including the importance level computation device 40 for the first time, first, the importance level computation device 40 transmits questionnaire information to the web browser 20 (S19).

The web browser 20 transmits the questionnaire information to the user terminal 10 (S21), and the user terminal 10 presents the questionnaire to the purchaser. The purchaser answers the questionnaire by operating the user terminal 10, and the user terminal 10 transmits the questionnaire answer result A to the web browser 20 (S23). The web browser 20 transmits the questionnaire answer result A to the importance level computation device 40 (S25). The importance level computation device 40 computes the initial value Pᵢₙᵢ of the importance level P (S26), and outputs the initial value Pᵢₙᵢ obtained through the computation to the web browser 20 (S27). In the web data management unit 43 of the importance level computation device 40, a combination of an identifier of the user who has performed access, the answer result A of the questionnaire, and the initial value Pᵢₙᵢ is managed as data.

The web browser 20 transmits the initial value Pᵢₙᵢ to the user terminal 10 (S29), and the user terminal 10 stores the initial value Pᵢₙᵢ in a storage unit (not illustrated). By storing the importance level P including the initial value Pᵢₙᵢ in the user terminal 10, in a case where a different web browser or web page is used, the stored importance level P is transmitted to the importance level computation device 40 via the web browser. The importance level computation device 40 can customize the web page by using the importance level P. With such a configuration, the importance level P obtained through use of a certain web page can be used for customization of another web page.

### Processing Flow of Importance Level Update

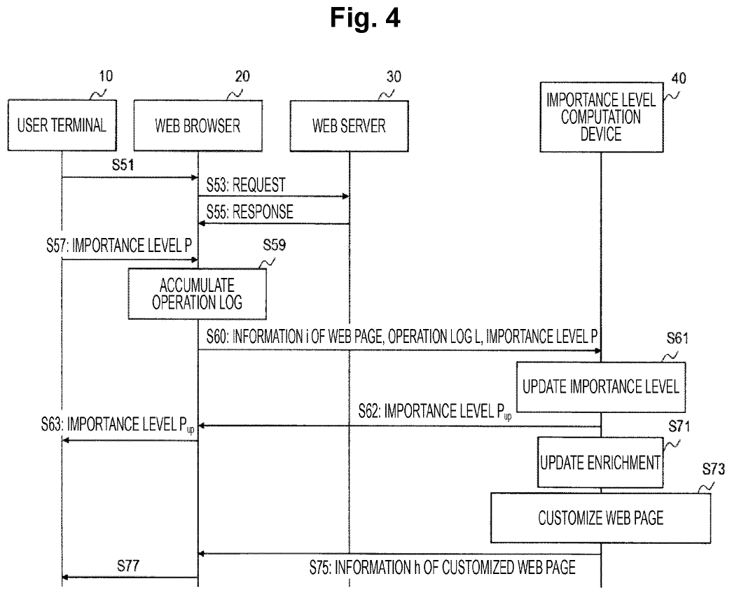

FIG. 4 illustrates an example of a processing flow of the importance level update, the enrichment update, and the layout customization.

The purchaser operates the user terminal 10 (S51) to access the web server 30 via the web browser 20. In this case, the web browser 20 transmits a request to the web server 30 (S53), and the web server 30 returns a response to the web browser 20 (S55).

The user terminal 10 outputs the importance level P to the web browser 20 (S57).

The web browser 20 accumulates the operation log L of the web page (S59).

The web browser 20 transmits the information i of the web page, the operation log L of the web page, and the importance level P to the importance level computation device 40 (S60).

The importance level computation unit 41 of the importance level computation device 40 extracts the human thing information g stored in the web data management unit 43 on the basis of the information i of the web page. The importance level computation unit 41 receives the human thing information g, the operation log L of the web page, and the importance level P for each piece of content, updates the importance level P by using the human thing information g and the operation log L of the web page for each piece of content (S61), and transmits the updated importance level Pᵤₚ to the web browser 20 (S62), and the web browser 20 transmits the updated importance level Pᵤₚ to the user terminal 10 (S63). The importance level P is stored in a storage unit (not illustrated) in the user terminal 10. The importance level P stored in the user terminal 10 can be updated by being input to the importance level computation device 40. Every time a predetermined period elapses or every time the purchaser accesses the web server 30 via the user terminal 10 and the web browser 20, the above-described S57 to S63 are performed. The web data management unit 43 of the importance level computation device 40 manages a combination of an identifier of the user who has performed access, the operation log L, and the importance level P as data.

### Processing Flow of Enrichment Update

The content enrichment calculation unit 44 of the importance level computation device 40 computes the enrichment f of content information in a web page by using the operation log L of the web page, the human thing information g, and the importance level P, and updates the enrichment f (S71). The web data management unit 43 of the importance level computation device 40 manages a combination of the information i of the web page, the human thing information g, and the enrichment f as data.

### Processing Flow of Layout Customization

The layout customization unit 45 of the importance level computation device 40 performs customization (rearranging, highlighting, layout change, and the like) of the web page according to the importance level P of the purchaser and the enrichment f of the web page (S73), and transmits the information h of the customized web page to the web browser 20 (S75).

The web browser 20 presents the customized web page on the basis of the information h to the user via the user terminal 10 (S77).

### Effects

With the above configuration, the presentation system can control display of information of a web page in accordance with user characteristics by using the importance level, display information that is regarded as important by a purchaser in an easily accessible manner, or display a web page that is enriching in information that is regarded as important by a purchaser in an easily accessible manner. Such display control enables the purchaser to quickly select a product.

### Modification Examples

In the present embodiment, the importance level computation unit 41, the content enrichment calculation unit 44, and the layout customization unit 45 are included in the importance level computation device 40. However, the importance level computation unit 41, the content enrichment calculation unit 44, and the layout customization unit 45 may exist as separate devices, and may be placed on the user terminal 10 side, for example.

In a case where the operation log L and the information i of the web page can be acquired without passing through the web browser 20, the importance level computation device 40 may be connected to the user terminal 10 side or the web server 30 side.

### Other Modification Examples

The present invention is not limited to the above embodiments and modification examples. For example, various processes described above may be executed not only in time series in accordance with the description but also in parallel or individually in accordance with processing abilities of a devices that executes the processes or as necessary. Modifications can be made as appropriate within the scope without departing from the concept of the present invention.

### Program and Recording Medium

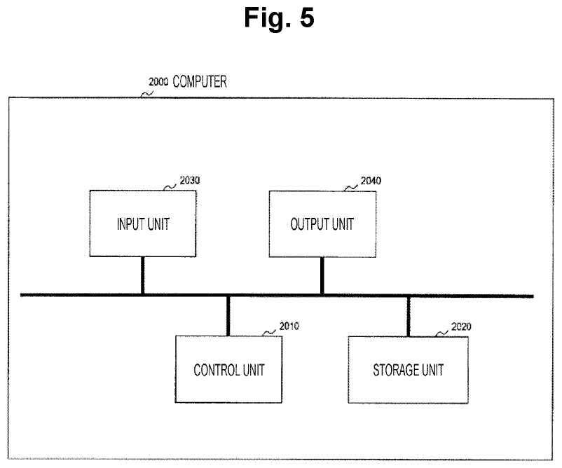

The above various processes can be implemented by loading a program for executing each step of the foregoing method to a storage unit 2020 of a computer shown in FIG. 5 and operating a control unit 2010, an input unit 2030, an output unit 2040, and the like.

The program in which the processing content is written may be recorded on a computer-readable recording medium. The computer-readable recording medium may be, for example, any recording medium such as a magnetic recording device, an optical disc, a magneto-optical recording medium, or a semiconductor memory.

The program is distributed by, for example, selling, transferring, or renting a portable recording medium such as a DVD or a CD-ROM on which the program is recorded. Further, a configuration may also be employed in which the program is stored in a storage device of a server computer and the program is distributed by transferring the program from the server computer to other computers via a network.

For example, a computer that executes such a program first temporarily stores a program recorded on a portable recording medium or a program transferred from the server computer in a storage device of the computer. Then, when executing processing, the computer reads the program stored in the recording medium of the computer and executes the processing according to the read program. As another mode of the program, the computer may read the program directly from the portable recording medium and execute processing according to the program, or alternatively, the computer may sequentially execute processing according to a received program every time the program is transferred from the server computer to the computer. The above-described processing may be executed by a so-called application service provider (ASP) type service that implements a processing function only by an execution instruction and result acquisition without transferring the program from the server computer to the computer. Note that the program in the present embodiment includes information that is used for processing by an electronic computer and is equivalent to the program (data or the like that is not a direct command to the computer but has property that defines processing performed by the computer).

Although the present devices are each configured by executing a predetermined program on a computer in the present embodiments, at least part of the processing content may be implemented by hardware.

1. A computation device comprising:
an importance level computation unit that computes an importance level that is an index indicating how much importance a user who intends to purchase a product that places on human information and thing information by using an operation log of a web page and human thing information, wherein
the human information is information regarding a user who sells a product, and the thing information is information regarding a product, and
the human thing information is information indicating whether each piece of content on the web page is the human information or the thing information.

2. The computation device according to claim 1, further comprising:
a content enrichment calculation unit that calculates, by using the operation log, the human thing information, and the importance level, enrichment including thing information enrichment indicating whether the thing information on the web page is enriched and human information enrichment indicating whether the human information on the web page is enriched.

3. The computation device according to claim 2, further comprising:
a layout customization unit that customizes a layout of the web page such that information placed importance by each purchaser is preferentially displayed on the basis of the importance level and the enrichment.

4. A computation method using a computation device, comprising:
an importance level computation step in which the computation device computes an importance level that is an index indicating how much importance a user who intends to purchase a product that places on human information and thing information by using an operation log of a web page and human thing information, wherein
the human information is information regarding a user who sells a product, and the thing information is information regarding a product, and
the human thing information is information indicating whether each piece of content on the web page is the human information or the thing information.

5. The computation method according to claim 4, further comprising:
a content enrichment calculation step in which the computation device calculates, by using the operation log, the human thing information, and the importance level, enrichment including thing information enrichment indicating whether the thing information on the web page is enriched and human information enrichment indicating whether the human information on the web page is enriched.

6. The computation method according to claim 5, further comprising:
a layout customization step in which the computation device customizes a layout of the web page such that information placed importance by each purchaser is preferentially displayed on the basis of the importance level and the enrichment.

7. (canceled)

8. A computer-readable non-transitory recording medium storing computer-executable program instructions that when executed by a processor cause a computer to execute a computation method comprising:
an importance level computation step in which the computation device computes an importance level that is an index indicating how much importance a user who intends to purchase a product that places on human information and thing information by using an operation log of a web page and human thing information, wherein
the human information is information regarding a user who sells a product, and the thing information is information regarding a product, and
the human thing information is information indicating whether each piece of content on the web page is the human information or the thing information.

9. The computation method according to claim 8, further comprising:
a content enrichment calculation step in which the computation device calculates, by using the operation log, the human thing information, and the importance level, enrichment including thing information enrichment indicating whether the thing information on the web page is enriched and human information enrichment indicating whether the human information on the web page is enriched.

10. The computation method according to claim 8, further comprising:
a layout customization step in which the computation device customizes a layout of the web page such that information placed importance by each purchaser is preferentially displayed on the basis of the importance level and the enrichment.

11. The computation device according to claim 1, further comprising:
an importance level calculation device that is connected to the web browser to able to communicate with it via a network and receives from the web browser a questionnaire response result regarding importance information, an importance level, and a web page operation log, receive web page information, calculate importance, and output customized web page information.

12. The computation device according to claim 11, wherein
the importance level calculation device calculates an initial value P ini of the importance level from the questionnaire response results regarding important information and updates the importance level from the operation log.

13. The computation device according to claim 12, wherein
the importance level calculation device uses the operation log L in which the importance level is known to calculate adequacy of the contents.

14. The computation device according to claim 12, wherein
the importance level calculation unit receives a questionnaire response result or the importance level, the web page operation log L, and the human object information stored in a web data management unit, and uses received values as inputs to determine the importance level.

15. The computation method according to claim 4, further comprising:
receiving from the web browser a questionnaire response result regarding importance information, an importance level, and a web page operation log, receive web page information, calculate importance, and output customized web page information.

16. The computation device according to claim 4, wherein
calculating an initial value P ini of the importance level from the questionnaire response results regarding important information and updates the importance level from the operation log.

17. The computation device according to claim 16, wherein
calculating adequacy of the contents using the operation log L in which the importance level P is known.

18. The computation device according to claim 16, wherein
receiving, the questionnaire response result or the importance level, the web page operation log L, and the human object information, and using received values as inputs to determine the importance level.

19. The computation method according to claim 8, further comprising:
receiving from the web browser a questionnaire response result regarding importance information, an importance level, and a web page operation log, receive web page information, calculate importance, and output customized web page information.

20. The computation device according to claim 8, wherein
calculating an initial value P ini of the importance level from the questionnaire response results regarding important information and updates the importance level from the operation log.

21. The computation device according to claim 20, wherein
calculating adequacy of the contents using the operation log L in which the importance level P is known.
